(19) United States
(12) Patent Application Publication
(10) Pub. No.: US 2026/0205404 A1
(43) Pub. Date: Jul. 16, 2026

(54) SIMULATING OPERATION OF A MULTINODE SYSTEM USING VIRTUALIZED CLUSTERS DEPLOYED IN CONTAINERS OF A PLATFORM-AS-A-SERVICE SYSTEM

(71) Applicant: Dell Products L.P., Round Rock, TX (US)

(72) Inventors: Mikhail Borisov, Dublin (IE); Danil Safronov, Warszawa (PL); Karthik Prabakaran, BANGALORE (IN)

(21) Appl. No.: 19/023,220

(22) Filed: Jan. 15, 2025

(51) Int. Cl. H04L 43/50; G06F 9/455

(52) U.S. Cl. CPC H04L 43/50; G06F 9/45558; G06F 2009/45562

(57) ABSTRACT

The technologies described herein are generally directed to using virtualized clusters deployed in containers of a platform-as-a-service system. For instance, a system can, based on an application system that includes at least two nodes, generate a testing model applicable to test respective operation of the at least two nodes. The system can further, based on a container-based virtualization layer, instantiate virtualized environments that host respective testing clusters applicable to the respective operation of the at least two nodes. Further, the system can, based on a testing plan applicable to the application system, interface with the testing clusters via a container orchestration layer.

### BACKGROUND

Modern data systems may use relatively large numbers of connected computer systems working in parallel to provide different services. For a variety of reasons, connected computer systems may exchange large amounts of data and jointly perform interdependent processes. Applications handled by these systems may have dramatic and unexpected fluctuations in the demand for application data. Thus, scalability testing may be performed on these systems to improve the handling of different combinations of potential operating conditions.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include, based on an application system that may include at least two nodes, generating a testing model applicable to test respective operation of the at least two nodes. The method may further include, based on a container-based virtualization layer, instantiating virtualized environments that host respective testing clusters applicable to the respective operation of the at least two nodes. Further, the method may include, based on a testing plan applicable to the application system, interfacing with the testing clusters via a container orchestration layer.

Additionally or alternatively, the application system may include a cloud-native object storage system. Additionally or alternatively, the container orchestration layer may include the container orchestration layer of a container orchestration system. Additionally or alternatively, the virtualized environments may include platform-as-a-service containers, and the platform-as-a-service containers may be instantiated via a docker tool of the container orchestration system. Additionally or alternatively, the testing clusters may include Kubernetes clusters applicable to testing the at least two nodes. Additionally or alternatively, the container-based virtualization layer may include a container network interface.

Additionally or alternatively, the container network interface may be configurable to link multiple ones of the at least two nodes. Additionally or alternatively, the virtualized environments respectively interface with the container-based virtualization layer via respective bridge interfaces. Additionally or alternatively, the virtualized environments respectively interface with the container-based virtualization layer via respective control plane components communicatively coupled to the respective bridge interfaces. Additionally or alternatively, the respective bridge interfaces may include Docker bridge interfaces.

Additionally or alternatively, the respective virtualized environments may be hosted by the respective at least two nodes, with a first virtualized environment and a second virtualized environment of the virtualized environments being hosted by a node of the at least two nodes, and the first virtualized environment may be configured to communicate with the second virtualized environment via a bridge interface comprised on the node. Additionally or alternatively, the node may include a first node, a third virtualized environment of the virtualized environments may be hosted by a second node of the nodes, and the first virtualized environment may be configured to communicate with the third virtualized environment via a container network interface that links the first node and the second node. Additionally or alternatively, the first virtualized environment may be configured to communicate with the third virtualized environment via an encapsulated network connection. Additionally or alternatively, the first virtualized environment may be configured to communicate with the third virtualized environment via an unencapsulated network connection. Additionally or alternatively, the testing plan may include a horizontal scalability testing plan.

An example system can operate as follows. At least one memory may store computer executable instructions, and at least one processor may be configured to process the computer executable instructions that, when executed by the at least one processor, facilitate performance of operations. The operations may include receiving, from a first cluster of a container orchestration system deployed in a first container of a platform-as-a-service system, a first message directed to a second cluster of the container orchestration system deployed in a second container of the platform-as-a-service system. The operations may further include interfacing with a bridge interface of the platform-as-a-service system to communicate the message to the second cluster of the container orchestration system, and the message may include an intranodal communication that was generated based on a horizontal scalability test of a data cluster storage system. Further, the operations may include receiving, via a container network interface linking the computing system node with another computing system node, a second message from a third cluster of the container orchestration system deployed in a third container of the platform-as-a-service system hosted by the other computing system node, and the second message may include an internodal communication that was generated based on the horizontal scalability test.

Additionally or alternatively, the first cluster was deployed in the first container by employing an interface of the container orchestration system that may be part of the platform-as-a-service system. Additionally or alternatively, the data cluster storage system may correspond to a multinodal system, and the horizontal scalability test may simulate operation of the multinodal system by testing operations of the first cluster, the second cluster, and the third cluster.

An example non-transitory machine-readable medium may include executable instructions that, when executed by at least one processor, facilitate performance of operations. The operations may include virtually linking at least two computing systems that may include employing a container virtualization layer, and the at least two computing systems may be applicable to host a scalability testing system. The operations may further include instantiating, in respective Linux containers, at least two virtual machines on the at least two computing systems. Further the operations may include testing a data storage system that may operate the at least two virtual machines in accordance with scalability testing data representative of a scalability testing plan configured to test the data storage system.

Additionally or alternatively, the scalability testing data may include horizontal scalability testing data representative of a horizontal scalability testing plan, and the container virtualization layer may be applicable to simulate internodal communications between the at least two virtual machines in accordance with the horizontal scalability testing plan.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate using virtualized clusters deployed in containers of a platform-as-a-service system, in accordance with one or more embodiments;

FIG. 2 is an architecture diagram of an example system that can facilitate using virtualized clusters deployed in containers of a platform-as-a-service system, in accordance with one or more embodiments;

FIG. 3 includes a diagram that illustrates aspects of example system that can facilitate using virtualized clusters deployed in containers of a platform-as-a-service system, in accordance with one or more embodiments;

FIG. 4 includes a diagram that illustrates aspects of example system that can facilitate using virtualized clusters deployed in containers of a platform-as-a-service system, in accordance with one or more embodiments;

FIG. 5 includes a diagram that illustrates aspects of example system that can facilitate using virtualized clusters deployed in containers of a platform-as-a-service system, in accordance with one or more embodiments;

FIG. 6 depicts a flow diagram representing example operations of an example method that can facilitate using virtualized clusters deployed in containers of a platform-as-a-service system, in accordance with one or more embodiments;

FIG. 7 depicts an example system that can facilitate using virtualized clusters deployed in containers of a platform-as-a-service system, in accordance with one or more embodiments;

FIG. 8 depicts an example non-transitory machine-readable medium that can include executable instructions that, when executed by a processor of a system, can facilitate using virtualized clusters deployed in containers of a platform-as-a-service system, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, systems the simulate relatively large numbers of physical or virtual nodes may improve the accuracy, performance, and efficiency of simulations, e.g., embodiments facilitate using lightweight virtual environments to host multiple virtual, independently operating, interconnected containerized, simulated nodes, thus reducing the number of nodes required for the simulation. One or more embodiments described herein are not abstract concepts; rather, they provide technical solutions to technical problems associated with the simulation of the operation of collections of interconnected computer systems. Moreover, implementations described herein can provide these solutions in a manner that cannot reliably be performed by a human or even a plurality of humans, e.g., solutions provided are described as being useful for simulating the interconnection of relatively large collections of computer systems.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

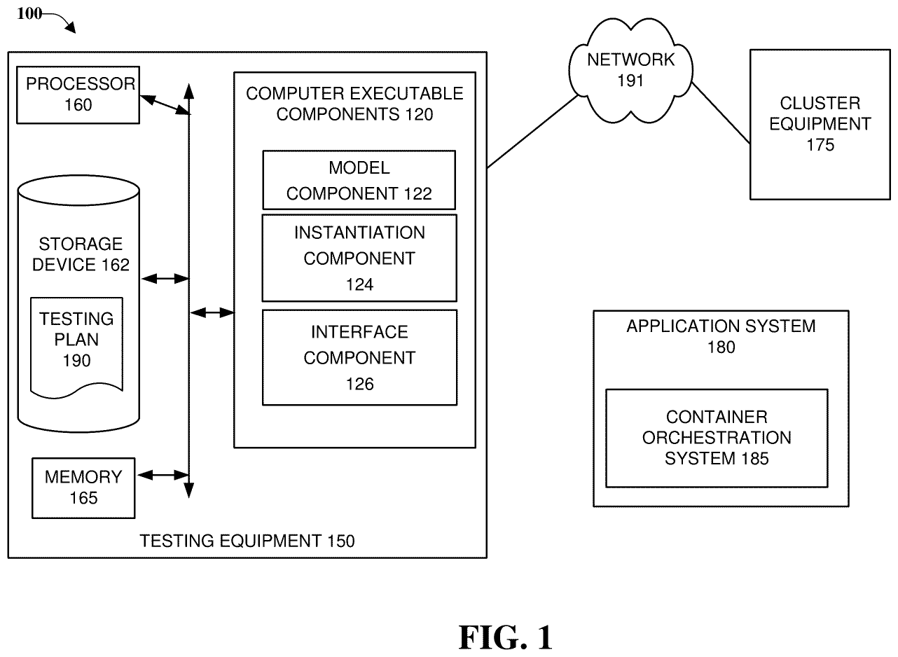

FIG. 1 is an architecture diagram of an example system 100 that can facilitate using virtualized clusters deployed in containers of a platform-as-a-service system, in accordance with one or more embodiments. For purposes of brevity, description of like elements and/or processes employed in other embodiments is omitted. As depicted, system 100 includes testing equipment 150 connected, via network 191, to cluster equipment 175. System 100 further includes application system 180 hosting container orchestration system 185.

As depicted, testing equipment 150 can include memory 165 that can store one or more computer and/or machine readable, writable, and/or executable components 120 and/or instructions. In embodiments, testing equipment 150 can further include processor 160. In one or more embodiments, computer executable components 120, when executed by processor 160, can facilitate performance of operations defined by the executable component(s) and/or instruction(s). Computer executable components 120 can include model component 122, instantiation component 124, interface component 126, and other components described or suggested by different embodiments described herein, that can improve the operation of system 100. Testing equipment 150 may further include storage device 162. In an example, storage device 162 may provide nonvolatile storage of data, data structures, computer executable instructions, and so forth.

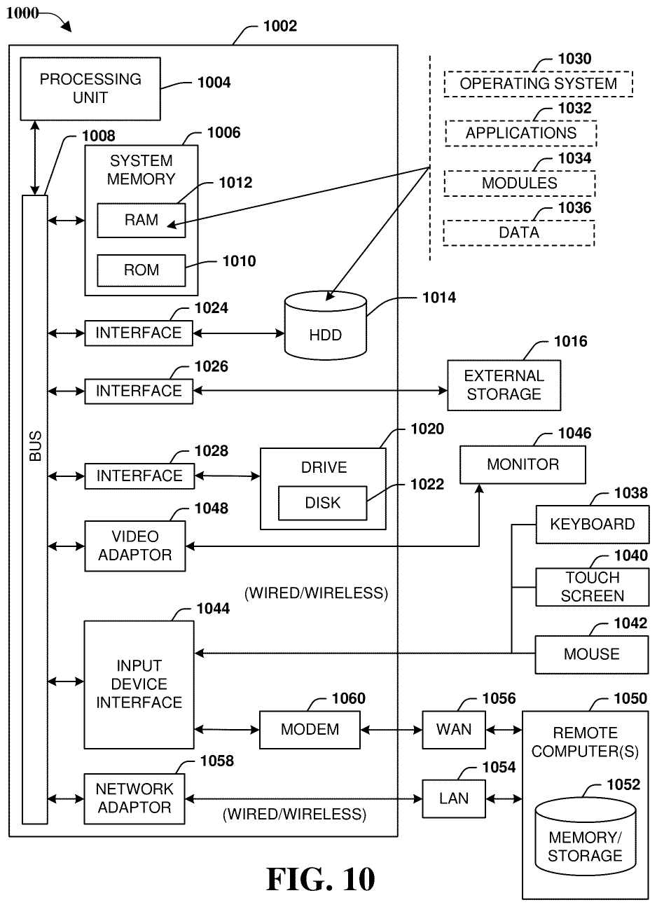

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

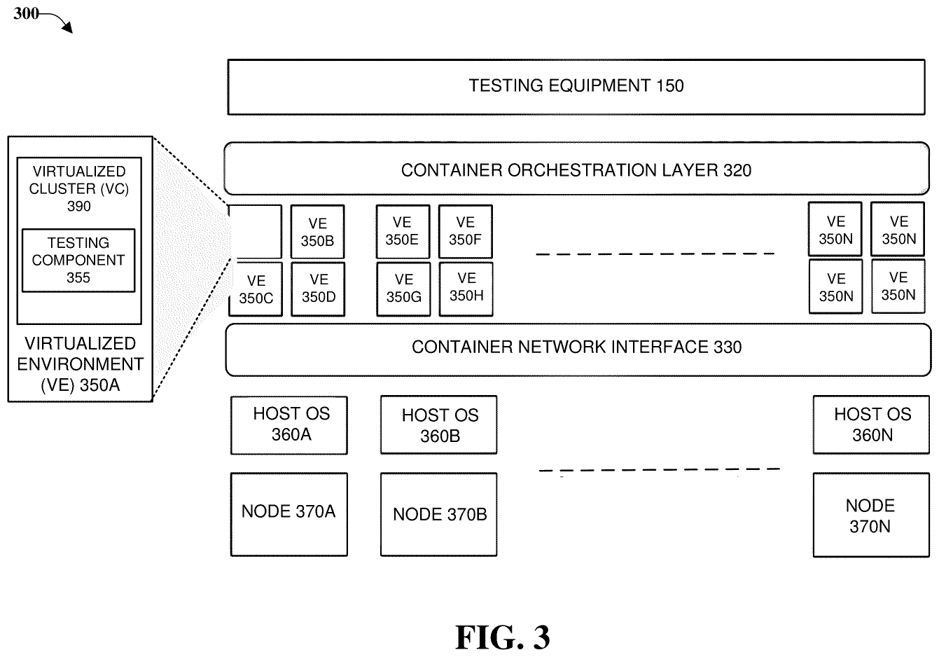

For convenience of explanation, Computer executable components 120, including model component 122, instantiation component 124, interface component 126, are discussed further with FIG. 3 below.

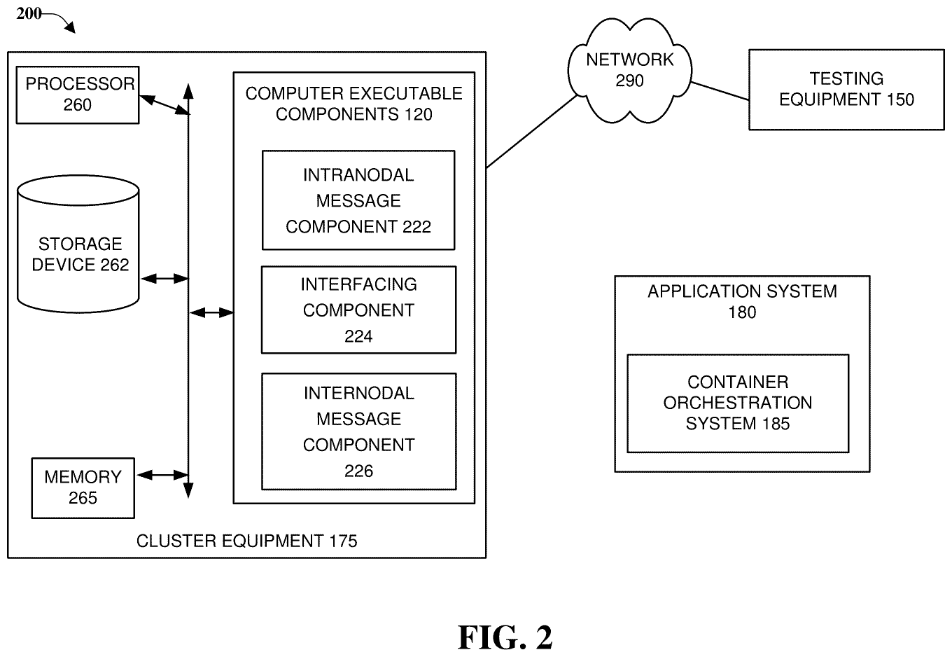

FIG. 2 is an architecture diagram of an example system 200 that can facilitate using virtualized clusters deployed in containers of a platform-as-a-service system, in accordance with one or more embodiments. For purposes of brevity, description of like elements and/or processes employed in other embodiments is omitted. As depicted, system 200 includes cluster equipment 175 connected, via network 290, to testing equipment 150. Cluster equipment 175 includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include intranodal message component 222, interfacing component 224, internodal message component 226, and other components described or suggested by different embodiments described herein, e.g., that can improve the operation of system 200, in accordance with one or more embodiments.

As discussed further with FIG. 10 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2(3GPP2 ) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

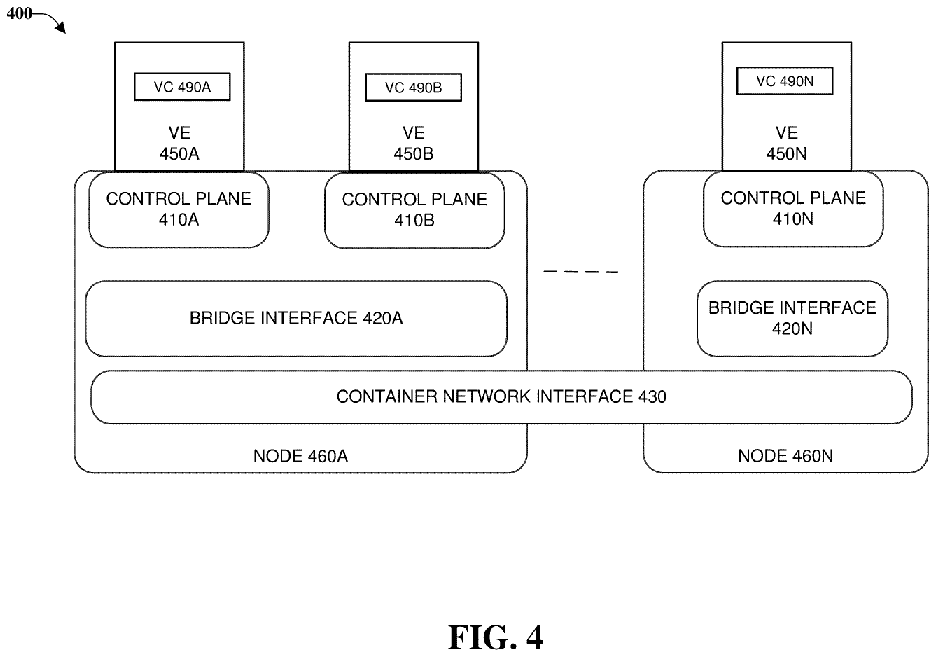

For convenience of explanation, Computer executable components 220, including intranodal message component 222, interfacing component 224, internodal message component 226 are discussed further with FIG. 4 below.

FIG. 3 includes a diagram that illustrates aspects of example system 300 that can facilitate using virtualized clusters deployed in containers of a platform-as-a-service system, in accordance with one or more embodiments. For purposes of brevity, description of like elements and/or processes employed in other embodiments is omitted. System 300 includes testing equipment 150, container orchestration layer 320, and container network interface 330. Application 310 communicates with virtualized environments (VEs) 350A-N of container orchestration layer 320. VEs 350A-N communicate with nodes 370A-N via host operations system (OS), respectively. Virtualized environments 350A-N respectively contain virtualized cluster (VC) 390 respectively hosting testing component 355.

Returning to the discussion of components of system 100, in one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of model component 122, which can in some implementations may, based on an application system that may include at least two nodes, generate a testing model applicable to test respective operation of the at least two nodes. For example, in one or more embodiments, model component 122 may, based on application system 180, operating using container orchestration system 185 (e.g., Kubernetes container orchestration software), generate a testing model applicable to test respective operation of the production implementation of container orchestration system 185 that implements application system 180.

In another example, memory 165 can store executable instructions that can facilitate generation of instantiation component 124, which in some implementations may, based on a container-based virtualization layer, instantiate virtualized environments that host respective VCs applicable to the respective operation of the at least two nodes. One or more implementations may use Linux containers to implement virtualized environments that may operate a set of processes isolated from a host system. Embodiments may utilize lightweight virtualization (isolation) technology because this facilitates having multiple containers share the same Linux kernel. Kubernetes In Docker (KIND) is a tool for running local Kubernetes clusters using Linux containers, with a single container simulating a Kubernetes node. In embodiments, KIND can run Kubernetes clusters locally, e.g., using a single node to simulate nodes of application system 180.

Returning to system 300, in one or more embodiments, instantiation component 124 can, based on a container-based virtualization layer, instantiate virtualized environments (e.g., virtualized environments 350A-N, Docker/Linux containers) that host respective testing clusters (e.g., VC 390, Kubernetes cluster) applicable to the simulation of container orchestration system 185 that implements application system 180.

In another example, memory 165 can store executable instructions that can facilitate generation of interface component 126, which in some implementations may, based on a testing plan applicable to the application system, interface with the testing clusters via a container orchestration layer. For example, in one or more embodiments, interface component 126 may, based on testing plan 190 applicable to application system 180, interface via container orchestration layer 320, with virtualized environments 350A-N and respective testing components 355 in VC 390.

FIG. 4 includes a diagram that illustrates aspects of example system 400 that can facilitate using virtualized clusters deployed in containers of a platform-as-a-service system, in accordance with one or more embodiments. For purposes of brevity, description of like elements and/or processes employed in other embodiments is omitted. System 400 includes nodes 460A-N, with node 460A hosting VEs 450A-B, and with node 460N hosting VE 450N. VEs 450A-B interface with node 460A, via control planes 410A-B, respectively, and VE 450N interfaces with node 460N via control plane 410N. Ves 450A-N respectively host VCs 490A-N.

Returning to the components of FIG. 2, in an example implementation of cluster equipment 175, memory 265 can store executable instructions that can facilitate generation of intranodal message component 222, which in some implementations, may receive, from a first cluster of a container orchestration system deployed in a first container of a platform-as-a-service system, a first message directed to a second cluster of the container orchestration system deployed in a second container of the platform-as-a-service system. For example, one or more embodiments, intranodal message component 222 may receive, from a first cluster of a container orchestration system (e.g., VC 490A, Kubernetes cluster) deployed in a first container of a platform-as-a-service system (e.g., VE 450A, Docker/Linux containers), a first message directed to a second cluster of the container orchestration system (e.g., VC 490B) deployed in a second container of the platform-as-a-service system (e.g., VE 450B). Both of these VCs 490A-B operate via node 460A, e.g., using a single node to simulate the operation of multiple nodes.

In an example implementation of cluster equipment 175, memory 265 can further store executable instructions that can facilitate generation of interfacing component 224, which in some implementations, may interface with a bridge interface of the platform-as-a-service system to communicate the message to the second cluster of the container orchestration system, and the message may include an intranodal communication that was generated based on a horizontal scalability test of a data cluster storage system. For example, in one or more embodiments, interfacing component 224 may interface with bridge interface 420A (e.g., a Docker bridge) to communicate the message from VE 450A to VE 450B. Because both VE 450A and 450B are hosted by node 460A, this message is an intranodal message. Further, in this example, this message was generated as part of testing performed in accordance with testing plan 190. In this example, testing plan 190 is directed to horizontal scalability testing, e.g., among VCs 490A to simulate operation of container orchestration system 185 of application system 180.

In an example implementation of cluster equipment 175, memory 265 can further store executable instructions that can facilitate generation of internodal message component 226, which in some implementations, may receive, via a container network interface linking the computing system node with another computing system node, a second message from a third cluster of the container orchestration system deployed in a third container of the platform-as-a-service system hosted by the other computing system node, and the second message may include an internodal communication that was generated based on the horizontal scalability test. For example, in one or more embodiments, internodal message component 226 may receive, via container network interface 430 linking node 460A to node 460B, a second message from a VC 490N deployed in VE 450N, hosted by node 460A.

Because both VE 450A is hosted by node 460A and VE 450N is hosted by 460B this message is an internodal message. In this example, this message was generated based on testing plan 190. Control planes 410A-B of node 460A interface with container network interface 430 via bridge interface 420A, and control plane 410N of node 460N interfaces with container network interface 430 via bridge interface 420N. It should be noted that both the intranodal message and the internodal message were generated to test internodal communication in container orchestration system 185. In some implementations, to improve the simulation of larger systems, the operation of bridge interface 420A and container network interface 430 may be adjusted to facilitate different connection characteristics of the larger systems. In some embodiments, intranodal communication by bridge interfaces 420A-B may employ virtual network interfaces, and internodal communication may employ encapsulated Layer 2 networking or unencapsulated Layer 3 networking, e.g., relying on direct IP routing between nodes.

As used herein, application system 180 may refer to a data system for storage of data and/or an application system. In an embodiment, the testing model may correspond to a horizontal testing model designed to test the scalability of clusters implemented by container orchestration system 185 (e.g., Kubernetes clusters). In an example, this data storage system is subject to testing by embodiments described above that utilize Kubernetes clusters in Docker containers on testing nodes. In some implementations, the Kubernetes clusters were selected to model the data storage system because the data storage system also operates using Kubernetes clusters. In example test system embodiments, using the Docker containers to host the test Kubernetes clusters may provide accurate modeling results, while reducing the overhead of the operation of the testing system, e.g., as compared to utilizing virtual machines installed directly on nodes.

For example, some elements of embodiments were selected because of advantages in the simulation/testing of application system 180, operating using container orchestration system 185 (e.g., Kubernetes clusters). These elements include, but are not limited to, virtualized environments 350A-N (e.g., containers of a platform-as-a-service system, KIND containers, and/or Linux containers), VCs (e.g., Kubernetes clusters), and container network interface 330 (e.g., a container virtualization layer enabled by a KIND interface).

For example, by using Linux containers and KIND to operate Kubernetes clusters in a testing system, KIND may be implemented with multinodal capabilities, e.g., multiple Kubernetes nodes of application system 180 nay be simulated using a single physical or virtual node 370A. Combining multiple nodes 370A-N thus may facilitate horizontal scalability testing of much larger Kubernetes cluster deployments, e.g., application system 180. As a result, more Kubernetes nodes may be simulated by embodiments using the same hardware, e.g., because overhead caused by a hypervisor, virtual machines, and a guest OS is removed from the process. In addition, one or more embodiments may facilitate actual pod deployment in the simulation system, e.g., VCs 490A-N may be copies of actual clusters deployed in the simulated system.

Examples and specific descriptive terms used herein are non-limiting, e.g., equivalent components may also be utilized without deviating from the spirit of embodiments. For example, as used herein, container orchestration layer 320 can broadly refer to: a Kubernetes system interface, an interface of an open-source container orchestration system, and an interface of infrastructure orchestration and management software. As used herein, VEs 450A-N can broadly refer to: Docker containers, containers of a platform-as-a-service system, Linux containers, local Kubernetes environment emulators, containerized application run-time environments, and lightweight virtualized environments. In some examples described herein, VCs 490A-N may be respectively deployed in VEs 450A-N via a KIND interface.

As used herein, VCs 490A-N can broadly refer to: Kubernetes clusters, virtual machines deployed in containers of a platform-as-a-service system. As used herein, testing component 355 can broadly refer to an application that operates and generates data for application 310, respectively operating in VCs 490A-N of VEs 450A-N. As used herein, nodes 470A-N can broadly refer to implementations via physical or virtual machines. As used herein, bridge interfaces 420A-B can broadly refer to: a local communication interface, a bridge interface of a platform-as-a-service system. As used herein, container network interface can broadly refer to: a non-local communication interface, a container virtualization layer, and an interface container enabled by a KIND interface.

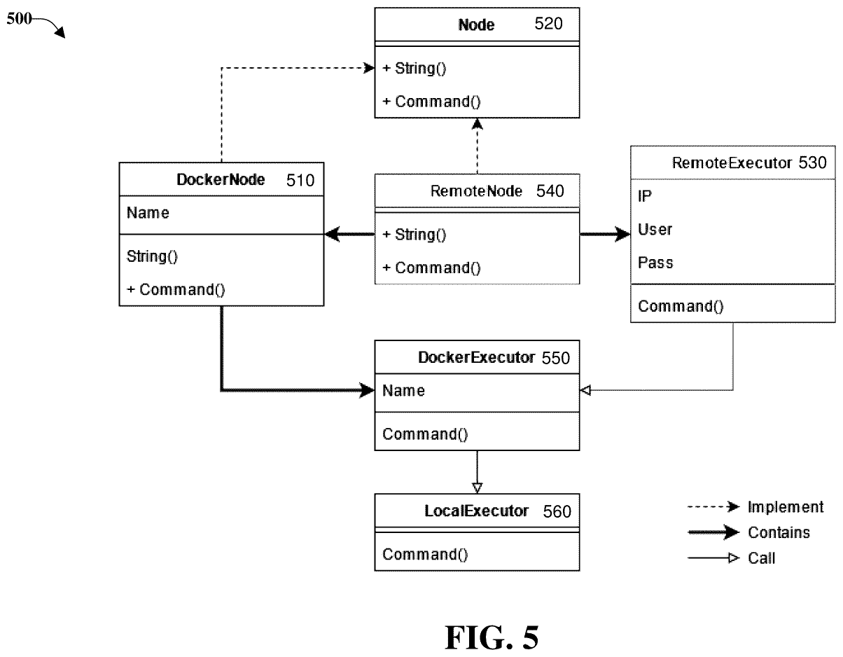

FIG. 5 includes a diagram that illustrates aspects of example system 500 that can facilitate using virtualized clusters deployed in containers of a platform-as-a-service system, in accordance with one or more embodiments. For purposes of brevity, description of like elements and/or processes employed in other embodiments is omitted. System 500 includes an entity relationship diagram that describes an implementation of one or more embodiments described herein. System 500 includes entities linked by implement, contains, and call relationship lines. Entities depicted include dockernode 510, node 520, remotenode 540, remoteexecutor 530, dockerexecutor 550, and localexecutor 560.

Remotenode 540 includes string() and command(), and contains dockernode 510 via string() and remoteexecutor 530 via command(), and implements node 520 via command(). Dockernode 510 contains name, string(), and command(), and implements dockerexecutor 550 via command() and node 520 via string(). Dockerexecutor 550 includes name and command() and calls localexecutor 560 via command(). Localexecutor 560 includes command(). Remoteexecutor 530 includes IP, user, pass, and command, and calls dockerexecutor 550 via command(). Node 520 includes string() and command().

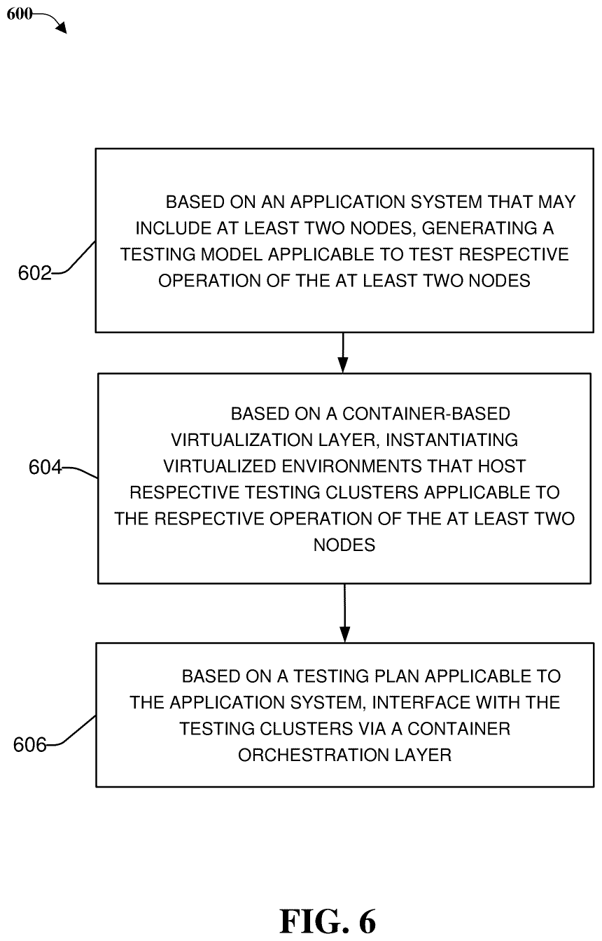

FIG. 6 depicts a flow diagram representing example operations of an example method 600 that can facilitate using virtualized clusters deployed in containers of a platform-as-a-service system, in accordance with one or more embodiments. For purposes of brevity, description of like elements and/or processes employed in other embodiments is omitted.

In some examples, one or more embodiments of method 600 can be implemented by model component 122, instantiation component 124, interface component 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, model component 122 of testing equipment 150 can, based on an application system that may include at least two nodes, generate a testing model applicable to test respective operation of the at least two nodes. At 604 of method 600, instantiation component 124 can, based on a container-based virtualization layer, instantiate virtualized environments that host respective testing clusters applicable to the respective operation of the at least two nodes. At 606 of method 600, interface component 126 can, based on a testing plan applicable to the application system, interface with the testing clusters via a container orchestration layer.

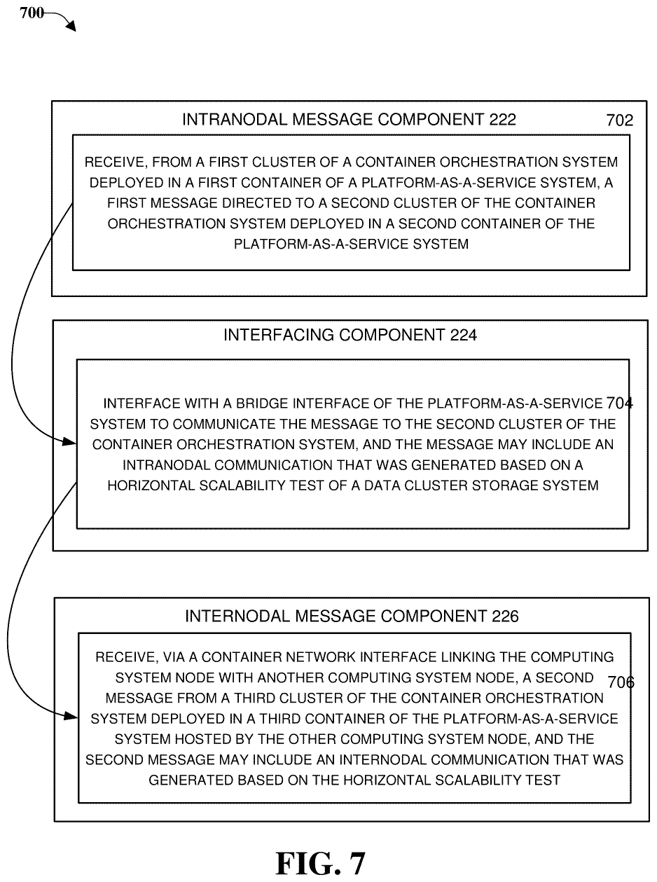

FIG. 7 depicts an example system 700 that can facilitate using testing clusters deployed in containers of a platform-as-a-service system, in accordance with one or more embodiments. For purposes of brevity, description of like elements and/or processes employed in other embodiments is omitted.

System 700 includes at least one memory that stores computer executable components, and at least one processor that executes the computer executable components stored in the at least one memory, with the computer executable components including intranodal message component 222, interfacing component 224, internodal message component 226, and other components that can be used to implement aspects of system 700, as described herein, in accordance with one or more embodiments.

At 702 of FIG. 7, intranodal message component 222 can receive, from a first cluster of a container orchestration system deployed in a first container of a platform-as-a-service system, a first message directed to a second cluster of the container orchestration system deployed in a second container of the platform-as-a-service system. At 704 of FIG. 7, interfacing component 224 can interface with a bridge interface of the platform-as-a-service system to communicate the message to the second cluster of the container orchestration system, and the message may include an intranodal communication that was generated based on a horizontal scalability test of a data cluster storage system. At 706 of FIG. 7, internodal message component 226 can receive, via a container network interface linking the computing system node with another computing system node, a second message from a third cluster of the container orchestration system deployed in a third container of the platform-as-a-service system hosted by the other computing system node, and the second message may include an internodal communication that was generated based on the horizontal scalability test.

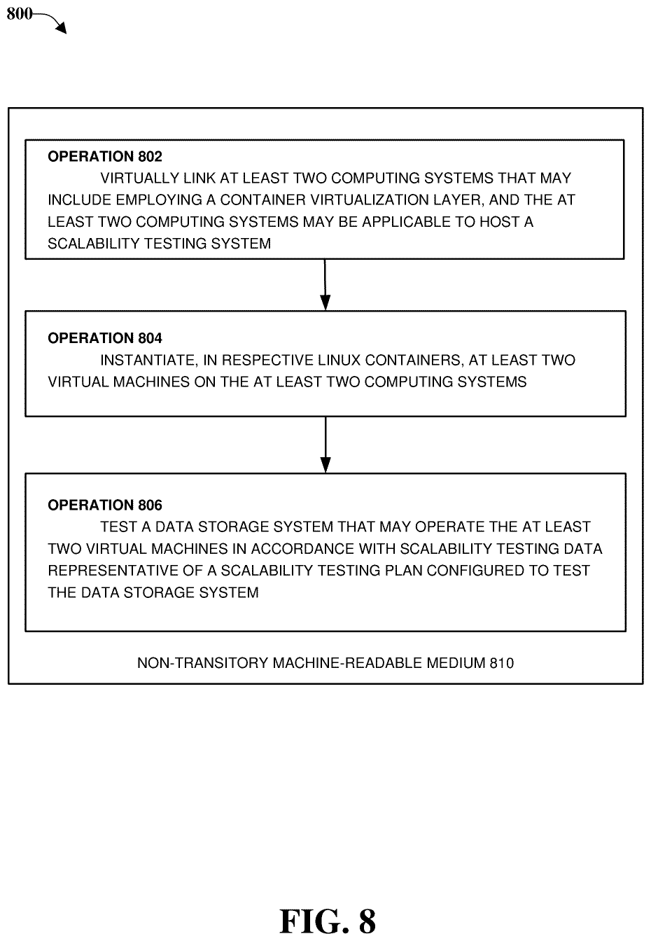

FIG. 8 depicts an example 800 non-transitory machine-readable medium 810 that can include executable instructions that, when executed by a processor of a system, can facilitate using testing clusters deployed in containers of a platform-as-a-service system, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can virtually link at least two computing systems that may include employing a container virtualization layer, and the at least two computing systems may be applicable to host a scalability testing system. The operations may further include operation 804 which can instantiate, in respective Linux containers, at least two virtual machines on the at least two computing systems. The operations may further include operation 806 which can test a data storage system that may operate the at least two virtual machines in accordance with scalability testing data representative of a scalability testing plan configured to test the data storage system.

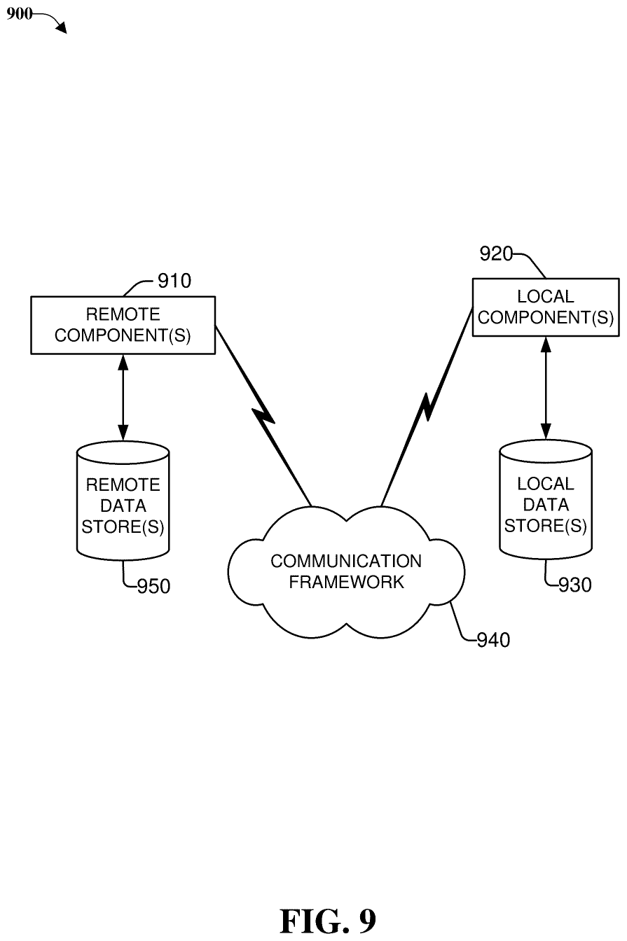

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random-access memory, synchronous dynamic random-access memory, double data rate synchronous dynamic random-access memory, enhanced synchronous dynamic random-access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2(3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
based on an application system comprising at least two nodes, generating, by a computing system comprising one or more processors, a testing model applicable to test respective operation of the at least two nodes;
based on a container-based virtualization layer, instantiating, by the computing system, virtualized environments that host respective testing clusters applicable to the respective operation of the at least two nodes; and
based on a testing plan applicable to the application system, interfacing, by the computing system, with the testing clusters via a container orchestration layer.

2. The method of claim 1, wherein the application system comprises a cloud-native object storage system.

3. The method of claim 1, wherein the container orchestration layer comprises the container orchestration layer of a Kubernetes container orchestration system.

4. The method of claim 3, wherein the virtualized environments comprise platform-as-a-service tools, and wherein the platform-as-a-service tools are instantiated via a docker tool of the container orchestration system.

5. The method of claim 1, wherein the testing clusters comprise Kubernetes clusters applicable to testing the at least two nodes.

6. The method of claim 1, wherein the container-based virtualization layer comprises a container network interface.

7. The method of claim 6, wherein the container network interface is configurable to link multiple containers of the at least two nodes.

8. The method of claim 1, wherein the virtualized environments respectively interface with the container-based virtualization layer via respective bridge interfaces.

9. The method of claim 8, wherein the virtualized environments respectively interface with the container-based virtualization layer via respective control plane components communicatively coupled to the respective bridge interfaces.

10. The method of claim 8, wherein the respective bridge interfaces comprise Docker bridge interfaces.

11. The method of claim 8, wherein the respective virtualized environments are hosted by the respective at least two nodes, wherein a first virtualized environment and a second virtualized environment of the virtualized environments are hosted by a node of the at least two nodes, and wherein the first virtualized environment is configured to communicate with the second virtualized environment via a bridge interface of the respective bridge interfaces, comprised on the node.

12. The method of claim 11, wherein the node comprises a first node, wherein a third virtualized environment of the virtualized environments is hosted by a second node of the nodes, and wherein the first virtualized environment is configured to communicate with the third virtualized environment via a container network interface that links the first node and the second node.

13. The method of claim 12, wherein the first virtualized environment is configured to communicate with the third virtualized environment via an encapsulated network connection.

14. The method of claim 12, wherein the first virtualized environment is configured to communicate with the third virtualized environment via an unencapsulated network connection.

15. The method of claim 1, wherein the testing plan comprises a horizontal scalability testing plan.

16. A computing system node, comprising:
at least one memory that stores computing executable instructions; and
at least one processor configured to process the computing executable instructions that, when executed by the at least one processor, facilitate performance of operations, comprising:
receiving, from a first cluster of a container orchestration system deployed in a first container of a platform-as-a-service system, a first message directed to a second cluster of the container orchestration system deployed in a second container of the platform-as-a-service system,
interfacing with a bridge interface of the platform-as-a-service system to communicate the message to the second cluster of the container orchestration system, wherein the message comprises an intranodal communication that was generated based on a horizontal scalability test of a data cluster storage system, and
receiving, via a container network interface linking the computing system node with another computing system node, a second message from a third cluster of the container orchestration system deployed in a third container of the platform-as-a-service system hosted by the other computing system node, wherein the second message comprises an internodal communication that was generated based on the horizontal scalability test.

17. The computing system node of claim 16, wherein the first cluster was deployed in the first container by employing an interface of the container orchestration system that is part of the platform-as-a-service system.

18. The computing system node of claim 17, wherein the data cluster storage system comprises a multinodal system, and wherein the horizontal scalability test simulates operation of the multinodal system by testing operations of the first cluster, the second cluster, and the third cluster.

19. A non-transitory machine-readable medium comprising executable instructions that, when executed by at least one processor of a computing system, facilitate performance of operations, the operations comprising:
virtually linking at least two computing systems comprising employing a container virtualization layer, wherein the at least two computing systems are applicable to host a scalability testing system;
instantiating, in respective Linux containers, at least two virtual machines on the at least two computing systems; and
testing a data storage system comprising operating the at least two virtual machines in accordance with scalability testing data representative of a scalability testing plan configured to test the data storage system.

20. The non-transitory machine-readable medium of claim 19, wherein the scalability testing data comprises horizontal scalability testing data representative of a horizontal scalability testing plan, and wherein the container virtualization layer is applicable to simulate internodal communications between the at least two virtual machines in accordance with the horizontal scalability testing plan.
